(19) United States
(12) Patent Application Publication
(10) Pub. No.: US 2012/0318548 A1
(43) Pub. Date: Dec. 20, 2012

(54) IMPACT TOOL

(75) Inventors: Tokuo HIRABAYASHI, Anjo-shi (JP); Manabu SUGIMOTO, Anjo-shi (JP)

(73) Assignee: MAKITA CORPORATION, Anjo-shi (JP)

(21) Appl. No.: 13/476,550

(22) Filed: May 21, 2012

(30) Foreign Application Priority Data
Jun. 17, 2011 (JP) 2011-135439

(51) Int. Cl. B25B 21/02

(52) U.S. Cl. 173/93.6

(57) ABSTRACT

In an impact tool, a hammer is divided into an inner-side main hammer engageable with or disengageable from an anvil and an outer-side sub hammer having a peripheral wall covering an outer periphery of the main hammer and formed as a separate member. The sub hammer is rotatably disposed in a rearward position, and the peripheral wall is engageable with the main hammer so that the main hammer and the sub hammer are unitarily rotatable. A connecting member is disposed between the main hammer and the peripheral wall in such a manner as to be movable between a connecting position and a disconnected position using a switching device. When the connecting member is moved in the connecting position, a drill mode is selected, in which retraction of the main hammer is restricted.

### BACKGROUND OF INVENTION

This application claims the benefit of Japanese Patent Application Number 2011-135439 filed on Jun. 17, 2011, the entirety of which is incorporated by reference.

### TECHNICAL FIELD

The present invention relates to an impact tool, such as an impact driver, which can generate a rotary impact force by engaging or disengaging a hammer with respect to an anvil protruding forward from a housing.

### BACKGROUND ART

An impact tool, such as an impact driver, includes a spindle disposed in a housing and configured to be driven to rotate by a motor, a hammer fitted onto the spindle and provided with engaging claws projecting at a front side thereof, the hammer and the spindle being connected through balls fitted into grooves formed in the hammer and the spindle, an anvil rotatably supported by the housing coaxial with the spindle, a front end of the anvil protruding forward from the housing and to which a bit is attached, and a rear end of the anvil being provided with radially extending arms, and a coil spring for urging the hammer toward an advanced position in which the engaging claws and the arms are engaged with each other in a rotational direction. According to this impact tool, when a torque of the anvil increases to a certain threshold, the hammer retreats while being guided by the balls rolling along the grooves, so that the engaging claws are disengaged from the arms. Thereafter, the hammer moves forward and rotates because of the urging force of the coil spring, so that the engaging claws are again engaged with the arms. Such engagement and disengagement actions are repeated, with the result that an intermittent rotary impact force (impact) is generated at the anvil.

For example, when a screw is secured into a pilot hole, a user first drills a small pilot hole using an electric drill, and then secures with a screw using an impact tool such as an impact driver. This requires the user to use different kinds of electric power tools in accordance with the works. As a result, preparation and replacement of a plurality of electric power tools are necessary and the workability deteriorates. A drilling operation can be performed by attaching a drill bit to the impact driver. However, when a pilot hole is drilled in a relatively brittle material such as tile, the material will break down due to generation of the impact.

In view of this, US Patent Publication No. 2010/0000750A1 discloses an impact tool comprising a spindle and a hammer, wherein a rear portion of the spindle has a flange having the same diameter as that of the hammer. Further, a connecting sleeve is arranged peripherally around the hammer and the flange so as to be operable to switch between an advanced position in which the connecting sleeve is only engaged with the hammer and a retracted position in which the connecting sleeve is engaged both with the hammer and the flange. In the advanced position of the connecting sleeve, retraction of the hammer is restricted and the impact tool is used in an impact mode. Meanwhile, in the retracted position of the connecting sleeve, the hammer and the spindle are connected in the rotational direction through the connecting sleeve and always rotate in a unitary fashion, so that the impact tool is used in a drill mode.

However, according to this mode switching mechanism as disclosed in US 2010/0000750A1, since the connecting sleeve is fitted onto the outer periphery of the hammer, the size of the impact mechanism increases in the diametrical direction, which is an obstacle to reduce the whole size of the impact tool. Further, since the impact tool includes the connecting sleeve and the flange provided on the spindle, the cost of the impact tool will be increased.

Therefore, it would be desirable to provide an impact tool, which can reduce the cost and the size, and which can provide a drill mode without causing a rotary impact force.

### SUMMARY OF INVENTION

In accordance with the present invention as embodied and described herein as a first aspect, an impact tool comprising a spindle disposed in a housing and configured to be driven to rotate by a motor, an anvil disposed at a front side of the spindle and rotatably supported by the housing coaxial with the spindle, a front end of the anvil protruding forward from the housing and to which a bit is attached, a hammer fitted onto the spindle and urged by a coil spring toward an advanced position in which the hammer is engaged with a rear end of the anvil, the hammer being configured to be movable in a front-and-rear direction in accordance with a torque of the anvil to engage with or disengage from the anvil, whereby rotation of the spindle is transmitted to the anvil as a rotary impact force. In this impact tool, the hammer is divided into an inner-side main hammer configured to be engageable with or disengageable from the anvil and an outer-side sub hammer having a peripheral wall covering an outer periphery of the main hammer and formed as a separate member from the main hammer. The sub hammer is disposed in a rearward position in which the sub hammer is rotatable with the peripheral wall thereof covering the outer periphery of the main hammer while movement of the main hammer in the front-and-rear direction is allowed. The peripheral wall of the sub hammer is engageable with the main hammer so that the main hammer and the sub hammer are unitarily rotatable. Further, a connecting member is disposed between the main hammer and the peripheral wall in such a manner as to be movable between a connecting position and a disconnected position. The connecting position is a position in which the main hammer and the peripheral wall are connected together in the front-and-rear direction in an advanced position of the main hammer. The disconnected position is a position in which the connection therebetween is disconnected. The connecting member is operable to move between the connecting position and the disconnected position by a switching device provided outside the housing. When the connecting member is moved in the connecting position using the switching device, a drill mode is selected, in which the anvil and the spindle rotate together while restricting retraction of the main hammer.

Preferably, in a second aspect, the impact tool according to the first aspect may be configured such that the connecting member is a ball movable in radial directions of the peripheral wall between the connecting position and the disconnected position. The connecting position is a position in which the ball is retained in the peripheral wall of the sub hammer and protrude inward from an inner peripheral surface of the peripheral wall into a fitting groove circumferentially formed in the outer periphery of the main hammer. The disconnected position is a position in which the ball is sunk into the inner peripheral surface of the peripheral wall and spaced apart from the fitting groove.

Preferably, in a third aspect, the impact tool according to the second aspect may be configured such that the switching device comprises a switch ring having a smaller-diameter portion and a large-diameter portion. The smaller-diameter portion is fitted onto the peripheral wall and slidably contacting the outer peripheral surface of the peripheral wall, and the large-diameter portion is spaced apart from the outer peripheral surface of the peripheral wall. The switch ring is slidably operable between a first slide position in which the large-diameter portion is positioned outside the ball to allow the ball to move into the disconnected position and a second slide position in which the small-diameter portion is positioned outside the ball to press the ball toward the connecting position.

Preferably, in a forth aspect, the impact tool according to the second aspect may be configured such that the coil spring is arranged between the main hammer and the sub hammer so that the sub hammer is urged toward the rearward position in which the sub hammer contacts a receiving portion disposed at a rear end of the spindle. Further, a ring-shaped groove may be formed in a rear surface of the sub hammer, and a plurality of balls may be received in the ring-shaped groove such that the balls partly extend beyond the rear surface and contact a front surface of the receiving portion.

With the configuration of the impact tool according to the first aspect, in addition to an impact mode as originally provided by the impact tool, a drill mode without causing impact can be used. Accordingly, it is not necessary for the user to change a plurality of electric power tools in accordance with works, which leads to improvement in the workability. Further, since the drill mode is realized by restricting retraction of the main hammer using the sub hammer that is divided from the hammer, reduction in the size of the impact tool can be achieved without increasing the impact mechanism in its diametrical direction. Further, switching the modes can be performed by a small number of assembling parts, which can prevent the rising cost. Of course, the necessary rotary impact force is ensured by the rotary motion of the sub hammer which unitarily rotates with the main hammer.

With the configuration of the impact tool according to the second or the third aspect, in addition to the advantageous effects of the first aspect, connection and disconnection between the main hammer and the sub hammer can be compactly and reliably performed in a space within the housing.

With the configuration of the impact tool according to the fourth aspect, in addition to the advantageous effects of the first aspect, the sub hammer can be disposed in the rearward position by the simple configuration using a coil spring for the impact mode. Further, even if the sub hammer is urged toward the rearward position by the coil spring, the rotational resistance of the sub hammer can be reduced and a smooth unitary rotation of the sub hammer following the main hammer can be performed. Further, a thrust load applied to the sub hammer can be received by the configuration which is compact in the axial direction.

Other and further objects, features and advantages of the present invention will appear more fully from the following description.

### BRIEF DESCRIPTION OF DRAWINGS

To better understand the claimed invention, and to show how the same may be carried into effect, reference will now be made, by way of example only, to the accompanying drawings.

FIG. 1 is a partial longitudinal sectional view of an impact driver.

FIG. 2 is an exploded perspective view of an internal mechanism of the impact driver.

FIG. 3 is an exploded perspective view of housings other than a main body housing.

FIG. 4 is a partial longitudinal sectional view of the impact driver in an impact mode.

FIG. 5 is a partial longitudinal sectional view of the impact driver in a drill mode.

### DETAILED DESCRIPTION OF INVENTION

With reference to the accompanying drawings, an embodiment of the present invention will be described in detail.

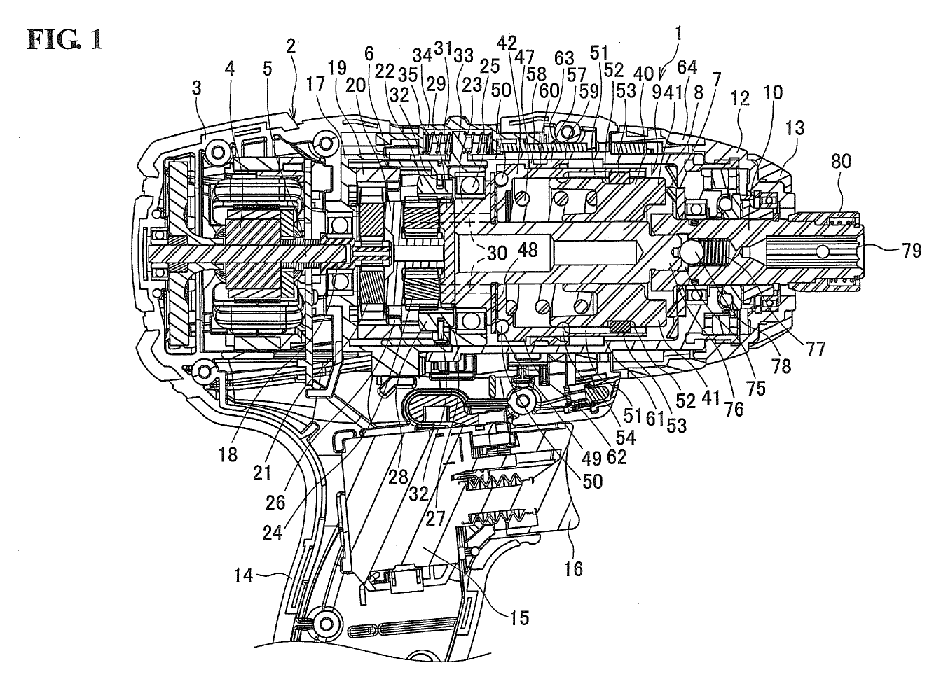

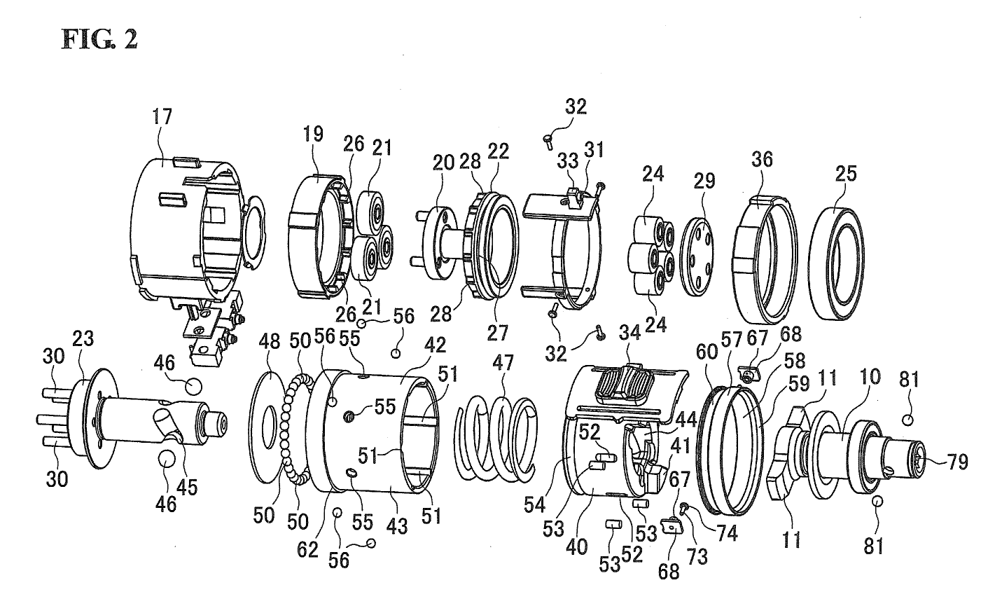

FIG. 1 shows an impact driver 1 as an embodiment of an impact tool, and FIG. 2 shows a part of the internal mechanism of the impact driver 1. The impact driver 1 includes a main body housing 2 which is assembled from right and left housing halves 3, 3. Further, the main body housing 2 includes, from the rear side of the main body housing 2 (right side of FIG. 1 corresponds to the “front” side), a motor 4, a planetary gear reduction mechanism 6, and a spindle 7. A tubular inner housing 8 is mounted at the front side of the main body housing 2, and accommodates the spindle 7 and an impact mechanism 9. An anvil 10 arranged at a front side of and coaxially with the spindle 7 is rotatably supported by the inner housing 8 and a front housing 12 fixed to the front end of the inner housing 8, and the anvil 10 protrudes forward from the main body housing 2. Reference numeral 13 indicates a ring-shaped bumper which is made of rubber and fitted onto the front end of the front housing 12. A handle 14 extends downward from a lower part of the main body housing 2, and a switch 15 having a trigger 16 is positioned in the handle 14.

The planetary gear reduction mechanism 6 is accommodated in a tubular gear housing 17 which is assembled with the main body housing 2. At a rear side of the gear housing 17, a pinion 18 provided on an output shaft 5 of the motor 4 extends forward and into the gear housing 17. The planetary gear reduction mechanism 6 includes a first carrier 20 and a second carrier 23. The first carrier 20 is configured to carry first-stage planetary gears 21 within a first internal gear 19 while planetary motion of the first-stage planetary gears 21 is allowed. The second carrier 23 is configured to carry second-stage planetary gears 24 within a second internal gear 22 while planetary motion of the second-stage planetary gears 24 is allowed. The pinion 18 is meshed with the first-stage planetary gears 21, and the second carrier 23 is integrally formed with the spindle 7 at the rear side of the spindle 7 and rotatably supported within the inner housing 8 by a ball bearing 25.

The first internal gear 19 has internal teeth 26 at its inner peripheral front-side surface, and the internal teeth 26 are provided equidistantly along the circumferential direction of the first internal gear 19. The second internal gear 22 has a ring-shaped engagement groove 27 at its outer peripheral front-side surface, and external teeth 28 are provided equidistantly along the circumferential direction of the second internal gear 22 at the outer peripheral rear-side surface thereof. The second internal gear 22 is slidable between an advanced position and a retracted position. The advanced position is a position in which the second internal gear 22 meshes both with a spur gear 29 which is integrally connected to the second carrier 23 at the rear side of the second carrier 23 and with the second-stage planetary gears 24. The retracted position is a position in which the second internal gear 22 only meshes with the second-stage planetary gears 24 with the internal teeth 26 of the first internal gear 19 and the external teeth 28 of the second internal gear 22 being meshed with each other.

The spur gear 29 is a separate gear disposed between the second carrier 23 and the planetary gears 24, and assembled by inserting supporting pins 30 for supporting the planetary gears 24 through the spur gear 29. The outer diameter of the second carrier 23 is smaller than that of the spur gear 29, wherein the outer diameter of the spur gear 29 corresponds to the major diameter including the distance of each gear tooth. Assuming that the spur gear 29 is integrally formed with the second carrier 23, it is necessary that the outer diameter of the second carrier 23 is greater than that of the spur gear 29 and a large-diameter ball bearing 25 has to be used for assembling the ball bearing 25 with the second carrier 23. On the contrary, according to this embodiment, the spur gear 29 is a discrete part separately formed from the second carrier 23, with the result that the spur gear 29 can be assembled with the second carrier 23 after assembling the ball bearing 25 and the second carrier 23. Therefore, it is not necessary that the outer diameter of the second carrier 23 and the inner diameter of the ball bearing 25 should be greater than the outer diameter of the spur gear 29. In this configuration, the second carrier 23 and the ball bearing 25 can be provided without increasing their sizes in the diametrical direction. As a result, the sizes of the gear housing 17 and the inner housing 8 in the diametrical direction can be reduced, and hence the size of the main body housing 2 can be reduced in the diametrical direction. Reference numeral 36 indicates a retaining ring for retaining the ball bearing 25 within the gear housing 17.

A slide ring 31 positioned at the outer periphery of the second internal gear 22 is capable of sliding in the front-and-rear direction along the inner peripheral surfaces of the gear housing 17 and the inner housing 8. The second internal gear 22 is connected to the slide ring 31 by inserting engagement pins 32 radially from outside to inside of the slide ring 31 to engage with the engagement groove 27 formed in the second internal gear 22. The slide ring 31 has a projection 33 which is formed at an upper outer periphery and protrudes upward from the gear housing 17. A slide button 34 is provided on the main body housing 2 so as to be slidable in the front-and-rear direction, and the projection 33 is retained by a slide button 34 through coil springs 35 disposed at front and rear sides of the projection 33.

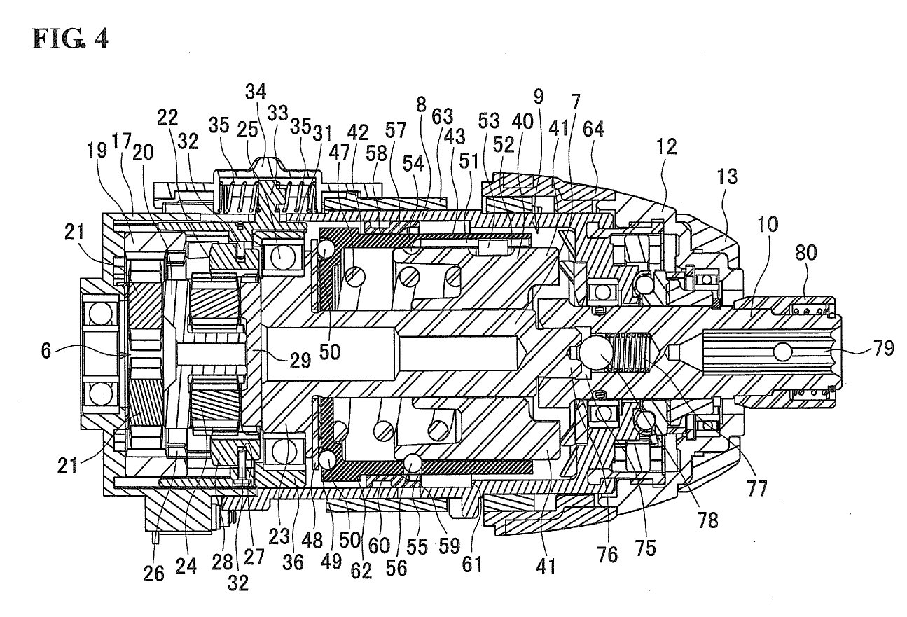

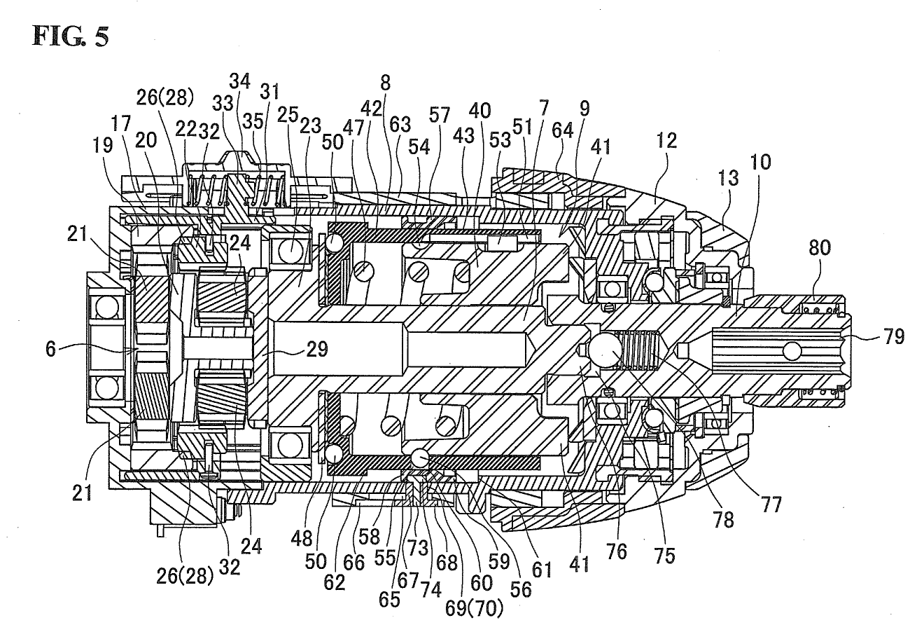

Accordingly, operating the slide button 34 to slide in the frontward direction or the rearward direction causes the second internal gear 22 to move through the slide ring 31 between the front position and the rear position. In other words, in an advanced position of the second internal gear 22 as shown in FIGS. 1 and 4, the second internal gear 22 unitarily rotates with the spur gear 29, so that the planetary motion of the planetary gears 24 is cancelled to achieve a high-speed mode, whereas in a retracted position of the second internal gear 22 as shown in FIG. 5, the second internal gear 22 becomes stationary to achieve a low-speed mode where the planetary motion of the planetary gears 24 is allowed.

The impact mechanism 9 includes a pair of arms 11 provided at the rear end of the anvil 10 and a hammer configured to be engaged with or disengaged from the arms 11. The hammer is divided into a tubular-shaped main hammer 40 and a sub hammer 42 shaped like a tube with a bottom. The main hammer 40 is fitted onto a front end portion of the spindle 7, and has a pair of engaging claws 41 projecting at the front surface thereof and engageable with the arms 11. The sub hammer 42 is coaxially and loosely fitted onto the spindle 7 at the rear side of the main hammer 40. Further, the sub hammer 42 opens at the front side thereof so that a peripheral wall 43 of the sub hammer 42 is inserted onto the main hammer 40 from the rear side of the main hammer 40. In other words, the diameter of the assembly made up of the main hammer 40 and the peripheral wall 43 of the sub hammer 42 corresponds to the outer diameter of a conventional hammer.

The main hammer 40 has reversed V-shaped grooves 44 formed in the inner peripheral surface of the main hammer 40. Each reversed V-shaped groove 44 extends and tapers from the front end toward the rear side of the main hammer 40. The spindle 7 has V-shaped grooves 45 formed in the outer peripheral surface of the spindle 7. Each V-shaped groove 45 extends with its front end portion facing toward the front side of the spindle 7. The reversed V-shaped grooves 44 and the V-shaped grooves 45 face each other and balls 46 are fitted between them, so that the main hammer 40 is connected to the spindle 7.

A coil spring 47 is fitted onto the spindle 7 and positioned between the main hammer 40 and the sub hammer 42, so that the main hammer 40 is urged toward a forward position in which the engaging claws 41 are engaged with the arms 11 and the sub hammer 42 is urged in a rearward direction. A washer 48 as a receiving portion is inserted onto the spindle 7 and positioned between the sub hammer 42 and the second carrier 23. A ring-shaped groove 49 is formed in the rear end surface of the sub hammer 42, and a plurality of balls 50 are received in the ring-shaped groove 49 and extend rearwardly beyond the rear end surface to form a thrust bearing. Accordingly, the sub hammer 42 is urged by the coil spring 47 in the rearward direction and pressed in a state that the balls 50 are capable of rolling to a rearward position so as to abut against the washer 48.

A plurality of guide grooves 51 are formed in the inner peripheral surface of the peripheral wall 43 of the sub hammer 42. The guide grooves 51 are provided equidistantly along the circumferential direction of the sub hammer 42 and axially extend from the front end toward the rear end of the sub hammer 42. A plurality of oblong grooves 52 which are shorter than the guide grooves 51 are formed in the outer periphery of the main hammer 40 at the same distances as the guide grooves 51, and cylindrical-shaped connecting pins 53 are fitted both into the guide grooves 51 and into the oblong grooves 52. Accordingly, the main hummer 40 and the sub hammer 42 are connected by the connecting pins 53 such that they are unitarily rotatable in the rotational direction while each of them is capable of moving in the axial direction respectively.

A ring-shaped fitting groove 54 is circumferentially formed in the outer peripheral surface of the main hammer 40 in the vicinity of the rear end of the main hammer 40, whereas a plurality of circular holes 55 are formed in the peripheral wall 43 of the sub hammer 42, which are radially penetrating the sub hammer 42 at positions between and at the rear end positions of the guide grooves 51. Balls 56 as a connecting member are fitted into the corresponding circular holes 55.

A switch ring 57 is fitted onto the peripheral wall 43 of the sub hammer 42. The switch ring 57 has two-stepped diameters. A rear side of the switch ring 57 is formed as a smaller-diameter portion 58 slidably contacting the outer peripheral surface of the peripheral wall 43, and a front side of the switch ring 57 is formed as a large-diameter portion 59 which is radially spaced apart from the outer peripheral surface of the peripheral wall 43. A ring-shaped groove 60 is formed in the outer peripheral surface of the smaller-diameter portion 58. The switch ring 57 is slidable in the front-and-rear direction between a front-side stepped portion 61 provided on the inner periphery of the inner housing 8 and a rear-side stepped portion 62 provided on the rear-side outer periphery of the peripheral wall 43.

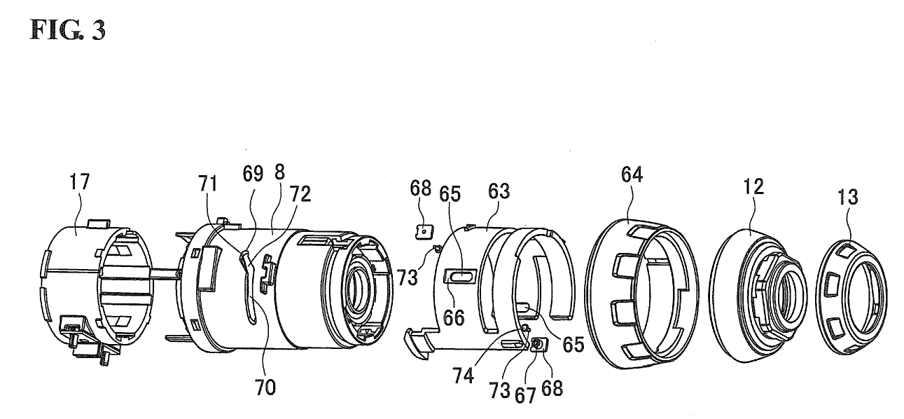

As best seen in FIG. 3, a connecting sleeve 63 is fitted onto the inner housing 8, and an operating sleeve 64 positioned at the front side of the main body housing 2 is mounted on a front-side outer periphery of the connecting sleeve 63 so as to be slidable with the connecting sleeve 63. A pair of through-holes 65 which are oblong openings extending in the front-and-rear direction are formed in the outer periphery of the connecting sleeve 63 at symmetrical positions with respect to a center point of the connecting sleeve 63. Further, the connecting sleeve 63 has a pair of rectangular-shaped guide recesses 66 in the outer peripheral surface thereof, and each guide recess 66 surrounds the corresponding through-hole 65.

Tubular-shaped guide holders 67 are formed on a square-shaped flange portion 68 which is fitted into the corresponding guide recesses 66. Further, the tubular-shaped guide holders 67 are inserted into the through-holes 65. The guide holders 67 radially penetrate through the through-holes 65 and extend into an inner region of the connecting sleeve 63 toward the axis of the connecting sleeve 63. The guide holders 67 are slidable in the front-and-rear direction with their flange portions 68 guided along the guide recesses 66. The inner housing 8 has a pair of guide grooves 69 consisting of a front-side groove 70 and a rear-side groove 71. The front-side groove 70 is formed in the circumferential direction thereof at a position corresponding to the front end of the through-hole 65 and into which the guide holder 67 is inserted. The rear-side groove 71 is formed in the circumferential direction at a position corresponding to the rear end of the through-hole 65, and a slanted groove 72 connecting the front-side groove 70 and the rear-side groove 71. Guide pins 73 are inserted from the inner region of the inner housing 8 (i.e., direction from the axis of the inner housing 8) and into the guide holders 67, and head portions 74 of the guide pins 73 are fitted into the ring-shaped groove 60 of the switch ring 57.

Therefore, when the operating sleeve 64 is rotationally manipulated to cause the connecting sleeve 63 to rotate clockwise (in the rightward direction) as viewed from front, the guide holders 67 also move rightward along the circumferential direction of the connecting sleeve 63. Thereafter, when the guide holders 67 move along the guide grooves 69 and reach the rear-side grooves 71, the guide holders 67 position at the rear ends of the through-holes 65. At this position, as best seen in FIG. 4, the switch ring 57 connected to the guide holders 67 through the guide pins 73 is moved into a retracted position (first slide position) in which the large-diameter portion 59 is positioned outside the balls 56. In this retracted position, the balls 56 are sunk into the inner peripheral surface of the peripheral wall 43 and movable to a disengagement position in which the balls 56 are spaced apart from the ring-shaped fitting groove 54 of the main hammer 40, whereby an impact mode which allows retraction of the main hammer 40 is achieved.

Meanwhile, when the operating sleeve 64 is rotationally manipulated to cause the connecting sleeve 63 to rotate anticlockwise (in the leftward direction) as viewed from front, the guide holders 67 also move leftward along the circumferential direction of the connecting sleeve 63. Thereafter, when the guide holders 67 move along the guide grooves 69 and reach the front-side grooves 70, the guide holders 67 position at the front ends of the through-holes 65. At this position, as best seen in FIG. 5, the switch ring 57 is moved into an advanced position (second slide position) in which the small-diameter portion 58 is positioned outside the balls 56. In this advanced position, the balls 56 are pressed by the small-diameter portion 58 and fitted into the ring-shaped fitting groove 54 of the main hammer 40 (i.e., retained in a connecting position), whereby a drill mode is achieved, in which the main hammer 40 and the sub hammer 42 are connected in the front-and-rear direction to limit the retraction of the main hammer 40. In this embodiment, the switch ring 57, the guide grooves 69, the connecting sleeve 63 having the through-holes 65, the operating sleeve 64, the guide holders 67, and the guide pins 73 constitute a switch device according to the present invention.

The anvil 10 has a shaft-receiving hole 75 formed in the rear surface at the shaft center position thereof. The spindle 7 has a front end portion 76 having a smaller diameter and sticking out from the front end of the spindle 7. The front end portion 76 of the spindle 7 is fitted into the shaft-receiving hole 75 of the anvil 10 and the front end of the spindle 7 is coaxially and rotatably supported by the anvil 10. A ball 78 provided in the shaft-receiving hole 75 is urged by a coil spring 77 and pressed against the end face of the front end portion 76 to receive a load in the thrust direction.

Further, at the front end of the anvil 10 which protrudes from the front housing 12, there are provided an insertion hole 79 for attaching a bit (not shown) and a chuck mechanism including a sleeve 80 which presses the balls 81 provided on the anvil 10 (see FIG. 2) into the insertion hole 79 at the retracted position so as to prevent the bit inserted into the insertion hole 79 from coming off from the anvil 9.

Operation of the impact driver 1 configured as described above will be described. First, description will be given of the operation in the impact mode as shown in FIG. 4 wherein the operating sleeve 64 has been rotationally manipulated to position the switch ring 57 in the retracted position. When the user manipulates the trigger 16 provided in the handle 14 to drive the motor 4, the rotation of the output shaft 5 of the motor 4 is transmitted to the spindle 7 through the planetary gear reduction mechanism 6 to thereby cause the spindle 7 to rotate. The spindle 7 then causes the main hammer 40 to rotate through the balls 46, so that the anvil 10 engaged with the main hammer 40 rotates. Therefore, a screw-tightening operation, etc. can be performed using the bit attached to the front end of the anvil 10. During this operation, the sub hammer 42 is connected in the rotational direction to the main hammer 40 through the connecting pins 53, so that the main hammer 40 and the sub hammer 42 rotate together.

As the screw-tightening operation proceeds and when a load applied to the anvil 10 increases to a certain threshold, the rotation of the main hammer 40 does not follow the rotation of the spindle 7, so that the main hammer 40 retreats or moves backward against the urging force of the coil spring 47 while the main hammer 40 rotates relatively with respect to the spindle 7 by the balls 46 rolling along the V-shaped grooves 45. In this time, the sub hammer 42 rotates together with the main hammer 40 through the connecting pins 53 while retraction of the main hammer 40 is allowed.

When the engaging claws 41 of the main hammer 40 are disengaged from the arms 11, the balls 46 are forced to roll by the urging force of the coil spring 47 and move forward along the V-shaped grooves 45, so that the main hammer 40 advances while rotating. Therefore, the engaging claws 41 of the main hammer 40 are reengaged with the arms 11 to generate a rotary impact force (impact). The main hammer 40 and the anvil 10 are repeatedly disengaged from and reengaged with each other to provide a retightening function of the impact driver 1.

During this operation, the sub hammer 42 also rotates following the main hammer 40, so that the engagement and disengagement of the hammer with respect to the anvil 10 are performed by the total mass of the main hammer 40 and the sub hammer 42. Therefore, even if the hammer is divided into the main hammer 40 and the sub hammer 42, the rotary impact force will not be decreased. Further, when the hammer rotates, the balls 50 on the rear end surface of the sub hammer 42 roll on the front surface of the washer 48 and a rotational resistance of the hammer is decreased. Therefore, the sub hammer 42 can be rotated smoothly even if the coil spring 47 expands and contracts in accordance with the forward and rearward movements of the main hammer 40. Further, even if the main hammer 40 repeats the forward and rearward movements upon generation of the impact, the sub hammer 42 is retained at its rearward position and does not move forward and rearward. Therefore, vibration can be suppressed upon generation of the impact.

Second, description will be given of the operation in the drill mode as shown in FIG. 5 wherein the operating sleeve 64 has been rotationally manipulated to position the switch ring 57 in the advanced position. When the user manipulates the trigger 16 to drive the motor 4, the main hammer 40 and the sub hammer 42 rotate together in accordance with the rotation of the spindle 7 to thereby unitarily rotate the anvil 10.

In this drill mode, even if a load applied to the anvil 10 increases, retraction of the main hammer 40 is restricted because of the balls 56, so that the engagement and disengagement of the main hammer 40 are not carried out with respect to the anvil 10. Therefore, the impact driver 1 does not generate impact and the anvil 10 unitarily rotates with the spindle 7.

According to the impact driver 1 as described above in this embodiment, the hammer is divided into the inner-side main hammer 40 and the outer-side sub hammer 42. The main hammer 40 is configured to be engageable with or disengageable from the anvil 10. The sub hammer 42 has the peripheral wall 43 covering the outer periphery of the main hammer 40 and is formed as a separate member from the main hammer 40. The sub hammer 42 is disposed in the rearward position in which the sub hammer 42 can rotate with the peripheral wall 43 covering the outer periphery of the main hammer 40 while movement of the main hammer 40 in the front-and-rear direction is allowed. The peripheral wall 43 of the sub hammer 43 is engageable with the main hammer 40 so that the main hammer 40 and the sub hammer 42 are unitarily rotatable. Further, the connecting member (e.g., balls 56) is disposed between the main hammer 40 and the peripheral wall 43 in such a manner as to be movable between the connecting position and the disconnected position. The connecting position is a position in which the main hammer 40 and the peripheral wall 43 are connected together in the front-and-rear direction in the advanced position of the main hammer 40. The disconnected position is a position in which the connection therebetween is disconnected. The connecting member 56 is operable to move between the connecting position and the disconnected position by the switching device provided outside the main body housing 2. When the connecting member is moved in the connecting position using the switching device, the drill mode is selected, in which the anvil 10 and the spindle 7 rotate together while retraction of the main hammer 40 is restricted.

With this arrangement, in addition to an impact mode as originally provided by the impact tool, the drill mode without causing impact can be used. Accordingly, it is not necessary for the user to change a plurality of electric power tools in accordance with works, which leads to improvement in the workability. Further, the drill mode is realized by restricting retraction of the main hammer 40 using the sub hammer 42 that is divided from the hammer 40. Therefore, reduction in the size of the impact driver 1 can be achieved without increasing the impact mechanism in its diametrical direction. Further, switching the modes can be performed by a small number of assembling parts, which can prevent the rising cost. Since the sub hammer 42 only performs the rotary motion following the main hammer 40 and does not move in the front-and-rear direction, an occurrence of vibration in the impact mode can be reduced. Of course, the necessary rotary impact force is ensured by the rotary motion of the sub hammer 42 which unitarily rotates with the main hammer 40.

In particular, the connecting member comprises balls 56 movable in radial directions of the peripheral wall 43 between the connecting position and the disconnected position. In the connecting position, the balls 56 are retained in the peripheral wall 43 of the sub hammer 42 and protrude inward from an inner peripheral surface of the peripheral wall 43 into the fitting groove 54 circumferentially formed in the outer periphery of the main hammer 40. In the disconnected position, the balls 56 are sunk into the inner peripheral surface of the peripheral wall 43 and spaced apart from the fitting groove 54. Further, the switching device comprises a switch ring 57 having the smaller-diameter portion 58 and the large-diameter portion 59. The smaller-diameter portion 58 is fitted onto the peripheral wall 43 and slidably contacting the outer peripheral surface of the peripheral wall 43, and the large-diameter portion 59 is spaced apart from the outer peripheral surface of the peripheral wall 43. The switch ring 57 is slidably operable between the first slide position and the second slide position. The first slide position is a position in which the large-diameter portion 59 is positioned outside the balls 56 to allow the balls 56 to move into the disconnected position. The second slide position is a position in which the small-diameter portion 58 is positioned outside the balls 56 to press the balls 56 toward the connecting position. Therefore, the connection and disconnection between the main hammer 40 and the sub hammer 42 can be compactly and reliably performed in a space within the inner housing 8.

Further, the coil spring 47 is arranged between the main hammer 40 and the sub hammer 42 so that the sub hammer 42 is urged toward the rearward position in which the sub hammer 42 contacts the washer 48 disposed at the rear end of the spindle 7. Further, the ring-shaped groove 49 is formed in the rear surface of the sub hammer 42, and a plurality of balls 50 are received in the ring-shaped groove 49 such that the balls 50 partly extend beyond the rear surface and contact the front surface of the washer 48. Therefore, the sub hammer 42 can be disposed in the rearward position by the simple configuration using the coil spring 47 for the impact mode. Further, even if the sub hammer 42 is urged toward the rearward position by the coil spring 47, the rotational resistance of the sub hammer 42 can be reduced and a smooth unitary rotation of the sub hammer 42 following the main hammer 40 can be performed. Further, a thrust load applied to the sub hammer 42 can be received by the configuration which is compact in the axial direction.

Although the present invention has been described in detail with reference to the above exemplary embodiment, the present invention is not limited to the above specific embodiment and various changes and modifications may be made without departing from the scope of the appended claims.

In the above embodiment, balls are used as the connecting member. However, the connecting member is not limited to the balls, and other members may be used, for example, pins loosely fitted into the peripheral wall in the radial directions and having semispherical front and rear ends may be employed. The number of the connecting members may be increased or decreased where necessary.

Further, the switch ring in the above embodiment is configured such that the small-diameter portion is positioned rearward while the large-diameter portion is positioned frontward, and the retreated position corresponds to the impact mode. However, the switch ring may be reversely assembled such that the advanced position corresponds to the impact mode.

The switching device other than the switch ring may be used where necessary. For example, instead of the structure using the integrally formed guide holders and guide pins, and the conversion mechanism having guide grooves and converting the rotation of the connecting sleeve into the movement of the switch ring in the front-and-rear direction, the slide positions of the switch ring may be changed by operating a slide button connected to the switch ring in the front-and-rear direction, which is a configuration similar to that of the speed change mechanism.

Further, the connection between the main hammer and the sub hammer in the rotational direction is not limited to the above structure using the connecting pins, and a connection using a key or spline may be used. The thrust bearing provided at the rear surface of the sub hammer may be modified. For example, the washer may be omitted and/or needles may be used instead of the balls.

Further, instead of the structure in which the sub hammer shaped like a tube with a bottom is urged by the coil spring for the impact mode toward the rearward position, a sleeve-shaped sub hammer may be simply and rotatably retained in the position at a rear side of the main hammer.

Other than the above, the housing may not include the inner housing. As an alternative, the housing may not include the inner housing and the front housing, and a hammer case accommodating the impact mechanism may be coupled to the main body housing at the front side of the main body housing. Further, the planetary gear reduction mechanism may be modified where necessary. For example, a three-stage speed switching mechanism or more may be used, or alternatively, the speed switching mechanism may be omitted. Of course, the present invention is not limited to an impact driver, and is applicable to other electric power tools such as an angle impact driver, an impact wrench, and an electric screw driver.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An impact tool comprising:
a spindle disposed in a housing and configured to be driven to rotate by a motor;
an anvil disposed at a front side of the spindle and rotatably supported by the housing coaxial with the spindle, a front end of the anvil protruding forward from the housing and to which a bit is attached;
a hammer fitted onto the spindle and urged by a coil spring toward an advanced position in which the hammer is engaged with a rear end of the anvil, the hammer being configured to be movable in a front-and-rear direction in accordance with a torque of the anvil to engage with or disengage from the anvil, whereby rotation of the spindle is transmitted to the anvil as a rotary impact force,
wherein the hammer is divided into an inner-side main hammer configured to be engageable with or disengageable from the anvil and an outer-side sub hammer having a peripheral wall covering an outer periphery of the main hammer and formed as a separate member from the main hammer,
wherein the sub hammer is disposed in a rearward position in which the sub hammer is rotatable with the peripheral wall thereof covering the outer periphery of the main hammer while movement of the main hammer in the front-and-rear direction is allowed, and the peripheral wall of the sub hammer is engageable with the main hammer so that the main hammer and the sub hammer are unitarily rotatable,
wherein a connecting member is disposed between the main hammer and the peripheral wall in such a manner as to be movable between a connecting position in which the main hammer and the peripheral wall are connected together in the front-and-rear direction in an advanced position of the main hammer and a disconnected position in which the connection therebetween is disconnected, and the connecting member is operable to move between the connecting position and the disconnected position by a switching device provided outside the housing, and
wherein when the connecting member is moved in the connecting position using the switching device, a drill mode is selected, in which the anvil and the spindle rotate together while retraction of the main hammer is restricted.

2. The impact tool according to claim 1, wherein the connecting member is a ball movable in radial directions of the peripheral wall between the connecting position in which the ball is retained in the peripheral wall of the sub hammer and protrude inward from an inner peripheral surface of the peripheral wall into a fitting groove circumferentially formed in the outer periphery of the main hammer and the disconnected position in which the ball is sunk into the inner peripheral surface of the peripheral wall and spaced apart from the fitting groove.

3. The impact tool according to claim 2, wherein the switching device comprises a switch ring having a smaller-diameter portion that is fitted onto the peripheral wall and slidably contacting the outer peripheral surface of the peripheral wall and a large-diameter portion that is spaced apart from the outer peripheral surface of the peripheral wall, and the switch ring is slidably operable between a first slide position in which the large-diameter portion is positioned outside the ball to allow the ball to move into the disconnected position and a second slide position in which the small-diameter portion is positioned outside the ball to press the ball toward the connecting position.

4. The impact tool according to claim 1, wherein the coil spring is arranged between the main hammer and the sub hammer so that the sub hammer is urged toward the rearward position in which the sub hammer contacts a receiving portion disposed at a rear end of the spindle, and wherein a ring-shaped groove is formed in a rear surface of the sub hammer, and a plurality of balls are received in the ring-shaped groove such that the balls partly extend beyond the rear surface and contact a front surface of the receiving portion.

5. The impact tool according to claim 1, wherein guide grooves are formed in an inner peripheral surface of the peripheral wall of the sub hammer along an axial direction of the sub hammer, and oblong grooves are formed in the outer periphery of the main hammer along an axial direction of the main hammer, and wherein connecting pins are fitted both into the guide grooves and into the oblong grooves so that the peripheral wall of the sub hammer and the main hammer are connected and unitarily rotatable.

6. The impact tool according to claim 3, wherein a tubular inner housing configured to receive therein an impact mechanism including the spindle and the hammer is assembled within the housing.

7. The impact tool according to claim 6, wherein a connecting sleeve configured to be rotatably operable from outside is fitted onto the inner housing, and tubular-shaped guide holders configured to be movable in the front-and-rear direction are engaged with the connecting sleeve, and wherein the guide holders penetrate through corresponding guide grooves formed in the inner housing and extend into a ring-shaped groove formed in an outer peripheral surface of the switch ring, so that when the connecting sleeve is rotationally manipulated, the guide holders are moved in the front-and-rear direction through the guide grooves to thereby cause the switch ring to slide between the first slide position and the second slide position.

8. The impact tool according to claim 7, wherein each of the guide grooves comprises a front-side groove formed in a circumferential direction of the inner housing, a rear-side groove formed in the circumferential direction of the inner housing, and a slanted groove connecting the front-side groove and the rear-side groove.

9. The impact tool according to claim 7, wherein guide pins are inserted into the guide holders with their head portions fitted into the ring-shaped groove.

10. The impact tool according to claim 7, wherein an operating sleeve positioned at a front side of the housing is mounted on the connecting sleeve such that they are unitarily rotatable.

11. The impact tool according to claim 1, wherein the main hammer has a pair of engaging claws at a front surface thereof, which are engageable with a pair of arms provided at a rear end of the anvil.

12. The impact tool according to claim 1, wherein the main hammer has reversed V-shaped grooves formed in an inner peripheral surface thereof, each extending and tapering from a front end toward a rear side of the main hammer, and the spindle has V-shaped grooves formed in an outer peripheral surface thereof, each extending with its front end portion facing toward a front side of the spindle, and wherein the reversed V-shaped grooves and the V-shaped grooves face each other with balls fitted therebetween, so that the main hammer is connected to the spindle.

13. The impact tool according to claim 4, wherein the receiving portion is a washer inserted onto the spindle.
